(19) United States
(12) Patent Application Publication
(10) Pub. No.: US 2026/0147938 A1
(43) Pub. Date: May 28, 2026

(54) METHODS FOR VERIFICATION OF ELECTRONIC DOCUMENTS AND RELATED ELECTRONIC DEVICES

(71) Applicant: MAERSK A/S, Copenhagen K (DK)

(72) Inventor: Fabio Krauss Stabel DE CARVALHO, Copenhagen K (DK)

(21) Appl. No.: 19/122,169

(22) PCT Filed: Oct. 11, 2023
(86) PCT No.: PCT/DK2023/050243

§ 371 Date: Apr. 17, 2025

(30) Foreign Application Priority Data
Oct. 18, 2022 (DK) PA202270501

(51) Int. Cl. G06F 21/64; H04L 9/00; H04L 9/32

(52) U.S. Cl. CPC G06F 21/64; H04L 9/3239; H04L 9/3247; H04L 9/50

(57) ABSTRACT

Disclosed is a method, performed by a first electronic device, for enabling verification of a second document. The second document is based on a first document by including a signature. The first document comprises a first primary part and a first secondary part. The method comprises determining, based on the first primary part of the first document, a first hash value. The method comprises including the first hash value in the first secondary part of the first document. The method comprises determining, based on the second document, a second hash value, wherein the second document includes a second primary part, a second secondary part and the signature. The method comprises transmitting a first transaction comprising the second hash value to a public ledger network.

The present disclosure pertains to the field of electronic document control and management. The present disclosure relates to methods for verification of electronic documents and related electronic devices.

### BACKGROUND

Documents, such as electronic documents, may require a signature, such as a digital signature. For example, parties to the contract are to provide their signatures. Digital signatures may be provided by a third-party authority, such as a signature provider and/or a signature certificate authority for verifying authenticity and integrity of sensitive documents (e.g., legal documents), such as for confirming the identity of each party signing the document and ensuring that the document has not been tampered during such signing process. However, the third-party authority can also pose risks, namely in terms of security. In particular, the third-party authority possesses sensitive documents and may become targets of attacks and disruptions (e.g., cyber-attacks via third party signature certificate authorities). Moreover, because the trust is placed entirely on such third-party authority, possibilities of collusions or manipulations cannot be ruled out (e.g., by changing internally the content of the document). Finally, signatory of the document may lose access to a platform provided by the third-party authority, e.g., while and/or within a time period for signing a legal document, upon a company ownership transferring and/or a bankruptcy process.

### SUMMARY

Accordingly, there is a need for electronic devices and methods for validating an electronic document, which mitigate, alleviate or address the shortcomings existing and provides for an additional layer of security by eliminating the need of a third-party authority. In other words, the present disclosure allows fingerprinting and/or integrity protection of content of signed documents and enables storage of the signed documents into an immutable ledger without relying on a third-party signature certificate authority.

Disclosed is a method, performed by a first electronic device, for enabling verification of a second document. The second document is based on a first document by including a signature. The first document comprises a first primary part and a first secondary part.

The method comprises determining, based on the first primary part of the first document, a first hash value. The method comprises including the first hash value in the first secondary part of the first document. The method comprises determining, based on the second document, a second hash value. The second document includes a second primary part, a second secondary part and the signature. The method comprises transmitting a first transaction comprising the second hash value to a public ledger network.

Further, a first electronic device is disclosed. The first electronic device comprises memory circuitry, processor circuitry, and an interface. The first electronic device is configured to perform any of the methods disclosed herein.

Disclosed is a computer readable storage medium storing one or more programs, the one or more programs comprising instructions, which when executed by a first electronic device cause the first electronic device to perform any of the methods disclosed herein.

It is an advantage of the present disclosure that the disclosed electronic device and method for enabling verification of a second document provide a robust protection of the second document (e.g., by signatories) in distributed manner without relying on a third party (e.g., an independent party). The present disclosure may lead to a reduced security risk of accepting a tampered document. Also, the present disclosure may lead to a reduced security risk in that it relies on a decentralized process, eliminating a third party. The disclosed public ledger allows for transparent, secure, tamper-proof, and immutable storing of the hash value guaranteeing tamper-resistance. No one can change or tamper with the second hash value recorded on the public ledger.

Disclosed is a method, performed by a second electronic device, for verifying a validity of an electronic document. The method comprises obtaining the electronic document. The electronic document comprises a first part and a second part. The method comprises determining, based on the first part of the electronic document, a third hash value. The method comprises obtaining a fourth hash value from a public ledger network. The fourth hash value is associated with a second document. The method comprises comparing the fourth hash value with the third hash value. The method comprises determining whether the comparison meets a criterion. The method comprises, upon the comparison meeting the criterion, successfully verifying the validity of the electronic document.

Further, a second electronic device is disclosed. The second electronic device comprises memory circuitry, processor circuitry, and an interface. The second electronic device is configured to perform any of the methods disclosed herein.

Disclosed is a computer readable storage medium storing one or more programs, the one or more programs comprising instructions, which when executed by a second electronic device cause the second electronic device to perform any of the methods disclosed herein.

It is an advantage of the present disclosure that the disclosed electronic device and method for verifying a validity of an electronic document provide a more secure verification of the validity of an electronic document, such as of the validity of the content and/or signature with regards to integrity. For example, the content of a received document can be validated in terms of integrity via the disclosed methods (as opposed to signature verification provided by signature providers, where the verification is only on whether the signature came from the signatory in a given date. The disclosed public ledger allows retrieving the fourth hash value that is transparent, tamper-proof, and immutable and can be used to validate against the third hash value, and thereby show if the electronic document has not been tampered with.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1A-1B are diagrams illustrating schematically an example representation 1 of a first document and an example representation 2 of a second document according to this disclosure,

FIG. 2 is a diagram illustrating schematically an example process for enabling verification of a second document according to this disclosure,

FIG. 3 is a diagram illustrating schematically an example process for verifying a validity of an electronic document according to this disclosure,

FIG. 4 is a flow-chart illustrating an exemplary method, performed by a first electronic device, for enabling verification of a second document according to this disclosure,

FIG. 5 is a block diagram illustrating an exemplary first electronic device according to this disclosure,

FIG. 6 is a flow-chart illustrating an exemplary method, performed by a second electronic device, for verifying a validity of an electronic document according to this disclosure, and

FIG. 7 is a block diagram illustrating an exemplary second electronic device according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

A document (e.g., a first document and/or a second document and/or an electronic document) disclosed herein may be seen as an electronic document, such as a document that can be processed by a computing device (e.g., by the electronic devices disclosed herein). A document disclosed herein may comprise a primary part and a secondary part. For example, the primary part is a body of the document. The secondary part is one or more of: a header part, a footer part, a hidden text part, a signature part, and a meta data part.

The document disclosed herein (e.g., a first document and/or a second document and/or an electronic document) may be a legal document, such as a contract, which can include one or more clauses. The body of a document may comprise one or more clauses of the document. For example, the header of the document comprises information about signing parties (e.g., contracting entities) and/or internal identifiers and/or any other suitable type of information. A clause dictates certain conditions under which parties to a contract agree to act during the term of the contract. Hence, liability and/or obligation depends on how each clause is written in a contract. A legal document needs to be verified and validated before signing such document.

The disclosed technique can be seen as a blockchain-based document verification technique to authenticate a document (such as a legal document, such as a contract).

The disclosed technique can authenticate the integrity of a document and let the document proceed to be signed by a remaining party upon successful verification and/or authentication. In other words, the disclosed technique can provide public proof of validity of a document. The disclosed technique can serve as a verification clearinghouse for documents by providing public proof of the validity (e.g., integrity) of a document or certification.

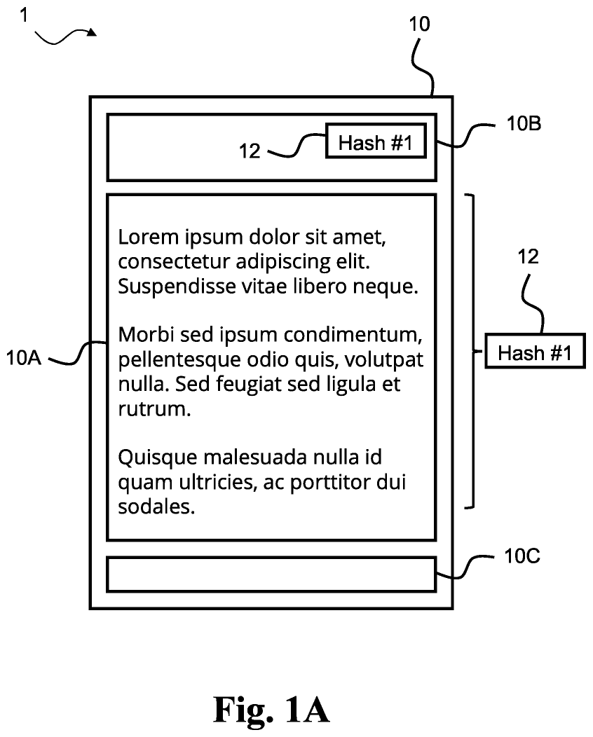

FIG. 1A-1B are diagrams illustrating schematically an example representation 1 of a first document (e.g., an unsigned document) and an example representation 2 of a second document (e.g., a signed document) according to this disclosure.

For example, the first document is a document sent to a party for signature while the second document is the first document having a signature.

FIG. 1A is a diagram illustrating an example representation 1 of a document, such as first document 10 (e.g., an unsigned document). For example, the first document 10 can be a legal document, such as contract between two or more parties. The first document 10 comprises a first primary part 10A and a first secondary part 10B, 10C. The first primary part 10A may be a body of the first document 10. The first primary part 10A is for example the body of the first document 10 which may include one or more clauses. The first secondary part 10B, 10C may be a header part and/or a footer part and/or an appendix of the first document 10. For example, the header 10B of the first document 10 comprises information about signing parties (e.g., contracting entities) and/or internal identifiers and/or any other suitable type of information.

FIG. 1A shows a first hash value 12A as part of the first secondary part 10B. According to the disclosed method, the first hash value 12A is determined, based on the first primary part 10A of the first document 10. The first hash value may be determined by applying a hash function to the first primary part 10A of the first document 10, e.g., the body of the first document 10.

For example, a hash function can be seen as a cryptographic function (e.g., a one-way cryptographic function) used for checking integrity protection. For example, the hash function takes as input the first primary part 10A of the first document 10B and provides as output the first hash value 12. In one or more examples, the hash function can be a Secure Hash Algorithm 256-bit, SHA-256. The first hash value 12 may be seen as a code enabling integrity check of the first primary part 10A of the first document 10 (e.g., the body of the first document). For example, the first hash value 12 is a value (e.g., an integer value, an alphanumeric value). In the disclosed method, the first hash value 12 is included, by the first electronic device, in the first secondary part 10B of the first document 10 (e.g., the header of the first document).

The present disclosure provides a method for enabling verification of a second document (e.g., second document 20 of FIG. 1B) by transmitting (e.g., registering and/or recording) a first transaction comprising a second hash value (e.g., second hash value 26 of FIG. 1B) to a public ledger network (e.g., a blockchain network). The disclosed method is performed by a first electronic device, such as a registerer device.

FIG. 1B is a diagram illustrating an example representation 2 of a second document 20 (e.g., a signed document). The second document 20 is based on a first document (e.g., first document 10 of FIG. 1A) by including a signature 24. In other words, the second document 20 is for example a signed version of the first document (e.g., first document 10 of FIG. 1A). For example, the second document 20 is the first document including the signature 24. The signature 24 may be performed via a party (e.g., via a platform provided by the third party to electronically and/or digitally signing documents and/or agreements).

The signature 24 may be an electronic and/or digital signature. The signature 24 may be a signature which is authorised and regulated by a signature certificate authority (e.g., the third party). The signature 24 may indicate that a first signing party approves and/or accepts one or more clauses comprised in the first document (e.g., the unsigned document), such as first document 10 of FIG. 1A.

The second document 20 may be a legal document, such as contract between two or more parties. For example, the second document comprises a second primary part 20A and a second secondary part 20B, 20C. The second primary part 20A may be a body of the second document 20. The body of the second document 20 may include one or more clauses. The second secondary part 20B, 20C may be a header part and/or a footer part and/or an appendix. For example, the header 20B of the second document 20 comprises information about signing parties (e.g., contracting entities) and/or internal identifiers and/or any other suitable type of information.

A second hash value 26 may be determined by applying a hash function to the second document 20 (e.g., the second primary part 20A of the second document, the second secondary part 20B, 20C of the second document, and the signature 24). For example, the hash function takes as input the second document 20 and provides as output the second hash value 26. In one or more examples, the hash function can be a Secure Hash Algorithm 256-bit, SHA-256. The second hash value may be an identifier of the second primary part of the second document 20A (e.g., body), the second secondary part of the second document (e.g., header) 20B, 20C, and the signature 24. The second hash value 26 may be a code enabling integrity check of the second document 20. For example, the second hash value 26 can be a numeric value (e.g., an integer value) and/or an alphanumeric value.

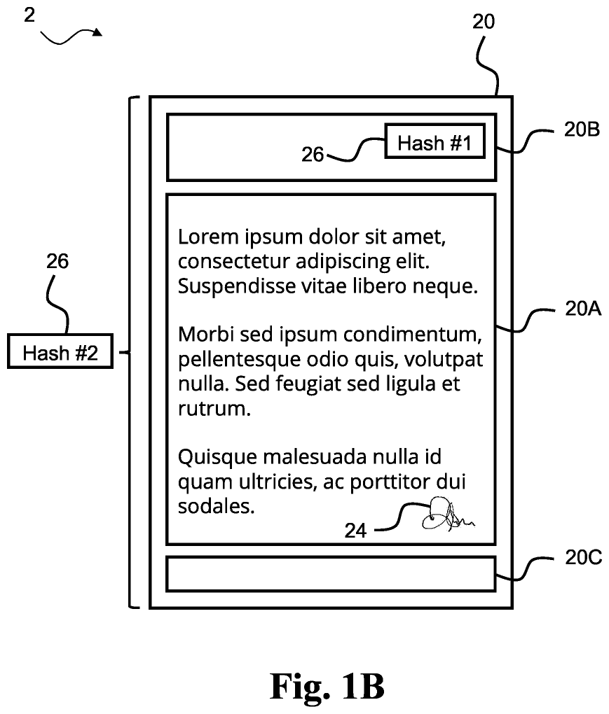

FIG. 2 is a diagram illustrating schematically an example process 500 for enabling verification of a second document (e.g., second document 20 of FIG. 1B) according to this disclosure.

The first electronic device 300 (e.g., acting as a registerer) transmits 502 a first transaction 504 comprising a second hash value 26 to a public ledger network 800, for enabling verification of the second document. Put differently, the first electronic device 300 may record and/or register and/or store a first transaction 504 comprising the second hash value 26 on the public ledger network 800. The first electronic device 300 transmits the first transaction 504 to a node of the public ledger network 800, which can then broadcast the recording task to other nodes in the public ledger network 800. Put differently, the first transaction 504 may be transmitted to one or more nodes (e.g., computing devices) in the public ledger network 800. The public ledger network 800 may be associated with a decentralised and/or distributed public ledger. The public ledger network 800 may be associated with an immutable public ledger (e.g., a ledger that maintains transaction unalterable).

The first transaction 504 may be a transaction to be validated by the one or more nodes of the public ledger network 800. The one or more nodes of the public ledger network 800 may validate the first transaction 504. The first transaction 504 comprising the second hash value 26 may be recorded (e.g., transmitted and appended) in the public ledger network by the one or more nodes forming the public ledger network 800. For example, the first transaction 504 comprising the second hash value 26 is recorded in the public ledger network using a data storing operation (e.g., a prefix-based operation, a storing operation, and a data encoding operation).

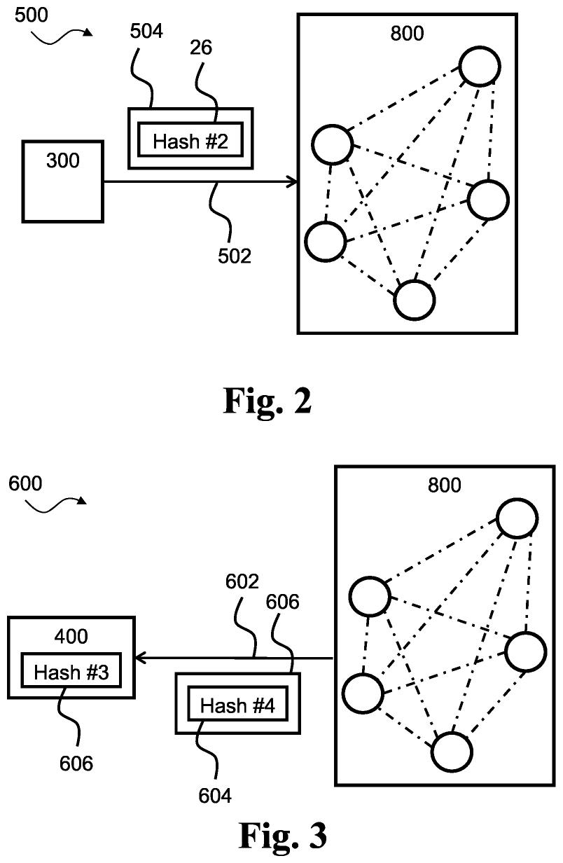

FIG. 3 is a diagram illustrating schematically an example process 600 performed by a second electronic device for verifying a validity of an electronic document according to this disclosure. The electronic document can be seen as a document for which the integrity is to be validated and/or verified. The electronic document can be in some examples an arbitrary document to be checked with respect to a corresponding hash value stored in the public ledger. The second electronic device 400 may be seen as a verifier device configured to verify the electronic document according to this disclosure.

The electronic document comprises a first part and a second part. The first part may be a body of the electronic document. For example, the body of the electronic document comprises one or more clauses of the electronic document. In one or more examples, the second part is a header of the electronic document. For example, the header of the electronic document comprises information about signing parties (e.g., contracting entities) and/or internal identifiers and/or any other suitable type of information.

The second electronic device 400 determines, based on the first part of the electronic document, a third hash value. The third hash value may be determined by applying a hash function to the to the first part, and the second part of the electronic document. The second electronic device 400 may determine the hash function based on transaction data from the public ledger network. The transaction data may be associated with a second transaction transmitted by a first electronic device 300 (e.g., a registerer device) for enabling verification of the electronic document. The transaction data may be associated with one or more parameters associated with the second document (e.g., whose hash is stored in the public ledger). The one or more parameters associated with the second document may comprise a hash function and/or a type of data storing operation.

The hash function applied to the entire electronic document (including the first part, and to the second part) may be the same hash function applied to the second document for recording the first transaction in the public ledger network illustrated in FIGS. 2 and 1B.

The second electronic device 400 obtains 602 a fourth hash value 604 from a public ledger network 800. The fourth hash value 604 is associated with the second document 20 of FIG. 1B. The fourth hash value 604 may be associated with the second document and was previously recorded (e.g., stored) in the public network ledger for future verification.

The second electronic device 400 compares the fourth hash value 604 with the third hash value 606. The second electronic device 400 determines whether the comparison meets a criterion. The second electronic device 400 successfully verifies the validity of the electronic document when the comparison meets the criterion.

The comparison may meet the criterion when the fourth hash value 604 is the same (e.g., equal to) as the third hash value 606.

The electronic document is an arbitrary document that can be checked to be a valid document or disregard as an invalid document (e.g., tampered).

In one or more examples, when comparison meets the criterion (e.g., the fourth hash value 604 is equal to the third hash value 606), the electronic document may be seen as the second document as a valid document which integrity has not been violates, e.g., not comprising one or more unauthorised modifications (e.g., not tampered).

The second electronic device 400 successfully verifies the validity of the electronic document when the fourth hash value 604 matches the third hash value 606.

The second document 20 (e.g., of FIG. 2) was transmitted (e.g., recorded), by the first electronic device 300 (e.g., of FIG. 2) in the public ledger network as illustrated in FIG. 2.

The electronic document held by device 400 may be validated as being the second document 20 not comprising one or more unauthorised modifications when the electronic document is valid by the criterion disclosed herein. By virtue of implementation of the blockchain process of the public ledger network 800, the fourth hash value retrieved is identical to the second hash value recorded.

In one or more examples, when comparison does not meet the criterion (e.g., the fourth hash value 604 is not equal to the third hash value 606), the electronic device 400 determines that the electronic document comprises one or more unauthorised modifications. When comparison does not meet the criterion, the electronic document is not the same as the second document. For example, the electronic document may be a tampered document or an incorrect document.

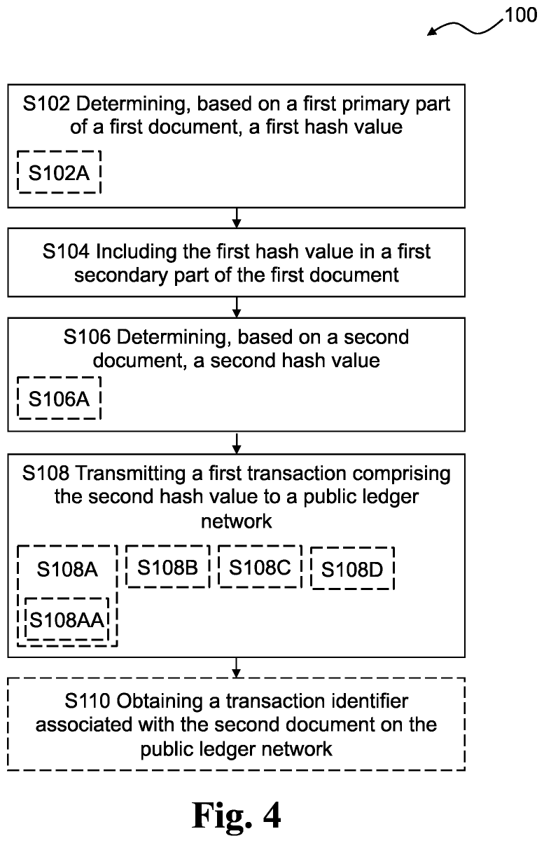

FIG. 4 shows a flow-chart of an exemplary method 100, performed by a first electronic device, for enabling verification of a second document according to the disclosure. The first electronic device may be the first electronic device disclosed herein, such as first electronic device 300 of FIGS. 2, 3, and 5.

The second document is based on a first document by including a signature. In one or more examples, the first document does not comprise the signature (e.g., an unsigned document). In one or more examples, the second document comprises a signature (e.g., a signed document). In one or more examples, the second document is a signed version of the first document. In one or more examples, the second document is the first document including the signature. The signature is, for example, performed via a third party (e.g., via a platform provided by the third party to electronically and/or digitally signing documents and/or agreements). For example, the third party can be seen as a signature certificate entity and/or a signature certificate authority. In one or more examples, the signature indicates that a first signing party approves and/or accepts one or more clauses comprised in the first document (e.g., the unsigned document).

The first document comprises a first primary part and a first secondary part. In one or more example methods, the first primary part is a body part of the first document, and wherein the first secondary part of the first document includes one or more of: a header part, a footer part, a hidden text part, a signature part, and a meta data part.

In one or more examples, the first primary part can be seen as a body of the first document (e.g., excluding a header and/or a footer and/or an appendix). For example, the body of the first document comprises one or more clauses of the first document. In one or more examples, the first secondary part can be seen as a header and/or a footer and/or a cover and/or an appendix and/or meta data of the first document. For example, the header of the first document comprises information about signing parties (e.g., contracting entities) and/or internal identifiers and/or any other suitable type of information. The meta data of the first document is for example the source code, and/or the title of the document, and/or one or more properties characterizing the first document.

The method 100 comprises determining S102, based on the first primary part of the first document, a first hash value. In one or more examples, the first hash value can be seen as a code for checking integrity of the first primary part of the first document. In other words, the first hash value may be a code for checking integrity of the body of the first document. The first hash value is used to protect integrity of the first primary part of the first document, such as the body of the first document. For example, a first hash value is a numeric value (e.g., an integer value and/or an alphanumeric value).

The method 100 comprises including S104 the first hash value in the first secondary part of the first document. In one or more examples, including the first hash value in the first secondary part of the first document comprises including (e.g., appending and/or adding and/or inserting) the first hash value (e.g., associated with the body of the first document) in the header of the first document, as illustrated in FIG. 1A. Put differently, the header of the first document includes, for example, the first hash value of the body of the first document. In one or more examples, including the first hash value in the first secondary part of the first document comprises not modifying the first primary part (e.g., a body) of the first document (e.g., to prevent modifying the first hash value), but modifying the first secondary part (e.g., a header). In one or more examples, the second primary part of the first document comprises the first hash value.

The method 100 comprises determining S106, based on the second document, a second hash value. The second document includes a second primary part, a second secondary part and the signature. In one or more example methods, the second primary part is a body part of the second document. In one or more example methods, the second secondary part of the second document includes one or more of: a header part, a footer part, a hidden text part, a signature part, and a meta data part. In one or more examples, the second document comprises the first secondary part including the first hash value, the first primary part and the signature. For example, the signature is performed by one or more signing parties involved in an agreement. For example, the signature is performed by the one or more signing parties in the first document comprising the first secondary part including the first hash value and the first primary part for provision of the second document. In other words, for example, the second document has the same contents of as the first primary part, the first secondary part (including the first hash value) and the signature. For example, the one or more signing parties can determine, based on the second document, one or more corresponding second hash values.

In one or more examples, the second primary part can be seen as a body of the second document (e.g., excluding a header and/or a footer and/or an appendix). For example, the body of the second document comprises one or more clauses of the second document.

For example, the body of the second document (e.g., signed document) can be seen as the body of the first document (e.g., unsigned document) including the signature. In one or more examples, the second secondary part can be seen as a header and/or a footer and/or a cover and/or an appendix of the second document. For example, the header of the second document comprises information about signing parties (e.g., contracting entities) and/or internal identifiers and/or any other suitable type of information. For example, the header of the second document may be the same as the header of the first document.

In one or more examples, the second hash value is an identifier of the second primary part of the second document (e.g., body), the second secondary part of the second document (e.g., header), and the signature. In other words, the second hash value is an identifier of the second document (e.g., the signed document). For example, the second hash value is a numeric value (e.g., an integer value). For example, the second hash value can be an alphanumeric value.

The method 100 comprises transmitting S108 a first transaction comprising the second hash value to a public ledger network. For example, the public ledger is a register, e.g., immutable public ledger, such as an immutable and decentralized public ledger. In one or more examples, transmitting the first transaction comprising the second hash value to the public ledger network can be seen as recording and/or registering the first transaction in the public ledger, via the public ledger network, e.g., via one or more nodes of the public ledger network. In one or more example methods, the first electronic device can be seen as a registerer device for registering and/or recording the first transaction comprising the second hash value in the public ledger. For example, the first transaction can be seen as a blockchain transaction. For example, the first transaction is transmitted across a part of the public ledger network and one or more nodes solve to add to a block of the blockchain or of the public ledger. For example, once added to the public ledger and having that block solved, the second hash value is appended to the blockchain and is now immutable. For example, the first transaction is assembled in a first device but not but not bitcoin-signed in the first device (such as using PSBT, Partially Signed Bitcoin Transaction). For example, the first transaction is bitcoin-signed in a second device and broadcasted to the public ledger network from a third device.

In one or more example methods, the signature is an electronic signature and/or a digital signature. In one or more examples, the signature can be signature which is authorised and regulated by a signature certificate authority (e.g., a signature generated using a digital certificate and cryptographically bound to the second document using a public key infrastructure, PKI). For example, the second document (e.g., signed document) is provided by the third-party signature certificate authority to the one or more signing parties.

In one or more example methods, determining S102 the first hash value comprises determining S102A the first hash value by applying a hash function to the first primary part of the first document. In one or more examples, a hash function can be seen as a cryptographic function (e.g., a one-way cryptographic function) for protecting integrity. For example, the hash function takes as input the first primary part of the first document and provides as output the first hash value. For example, the hash function generates, based on first primary part of the first document (e.g., input data characterised by a length), the first hash value (e.g., a fixed-size output of the input data). In one or more examples, the hash function can be a Secure Hash Algorithm 256-bit, SHA-256. In one or more examples, the hash function can be a self-descriptive hash function, such as a multi-hash function. In one or more examples, the hash function can be a hash function pre-agreed by the one or more signing parties to be a same hash function for performing encryption of the first primary part of the first document in order to transmit the first transaction to the public ledger network and/or for verifying a validity of the second document, such as a signed document by searching for the second hash value in the public ledger network. For example, the hash function is selected based on the desired level of security.

In one or more example methods, determining S106 the second hash value comprises determining S106A the second hash value by applying a hash function to the second document that includes the second primary part, the second secondary part and the signature. In one or more examples, the hash function takes as input the second document (e.g., the second primary part, the second secondary part (including the first hash value) and the signature). For example, the hash function takes as output the second hash value. For example, the hash function generates, based on the second document (e.g., input data characterised by a length), the second hash value (e.g., a fixed-size output of encrypted data). In one or more examples, the hash function can be a Secure Hash Algorithm 256-bit, SHA-256. In one or more examples, the hash function can be a self-descriptive hash function, such as a multihash function. In one or more examples, the hash function can be a hash function pre-agreed by the one or more signing parties to be a same hash function for performing encryption of the second document (e.g., the second primary part, the second secondary part and the signature) in order to transmit the first transaction to the public ledger network and/or for verifying a validity of the second document, such as a signed document by searching for the second hash value in the public ledger network. A first hash function which takes as input the first primary part of the first document for provision of the first hash value may be the same as a second hash function that takes as input the second document for provision of the second hash value. The first hash function may be different from the second hash function. For verifying the validity of the second document, the one or more signing parties may require the sequence in which the first and second hash functions are applied to the first primary part of the first document and the second document, respectively. In some examples, the hash function applied to generate the first hash value may be the same as the hash function applied to generate the second hash value. In some examples, the hash function applied to generate the first hash value may be a different hash function than the hash function applied to generate the second hash value.

In one or more example methods, the second secondary part of the second document is based on the first secondary part of the first document. In one or more examples, the second secondary part (e.g., header) of the second document includes the first secondary part (e.g., header) of the first document (as illustrated in FIGS. 1A-1B) which includes the first hash value. The header of the second document may be based on the header of the first document. The header of the second document may be the same of the header of the first document. Put differently, the header of both the second document and the first document comprises the first hash value.

In one or more example methods, transmitting S108 the first transaction comprising the second hash value to the public ledger network comprises generating S108A the first transaction comprising the second hash value. In one or more example methods, transmitting S108 the first transaction comprising the second hash value to the public ledger network comprises transmitting S108B the first transaction to the public ledger network. In one or more examples, transmitting the first transaction comprising the second hash value to the public ledger network comprises broadcasting the first transaction to the public ledger network. Put differently, the first transaction may be transmitted to one or more nodes (e.g., computing devices) in the public ledger network. For example, each node of the one or more nodes comprised in the public ledger network can obtain (e.g., receive) an identical copy of the first transaction comprising the second hash value. In one or more examples, the public ledger network is a distributed and/or decentralised public ledger. And the first transaction is validated by nodes of the public ledger network. In one or more examples, the first transaction is a valid transaction. Put differently, the one or more nodes may approve the first transaction as valid (e.g., validate the first transaction). A block associated with the first transaction may be appended to a chain of blocks (e.g., blocks representative of other independent transactions) in the public ledger network (e.g., a blockchain network). In other words, a block associated with the first transaction is, for example, recorded (e.g., transmitted and appended to a block) in the public ledger. For example, generating the first transaction can comprise creating a blockchain transaction object representative of the first transaction.

In one or more examples, the generation and/or the transmission of the first transaction can be performed by different (e.g., independent) electronic devices. A first primary electronic device may generate the first transaction. The first primary electronic device may not perform transaction signing, such as to verify transaction credentials for recording the first transaction in the public ledger network (e.g., Partially Signed Bitcoin Transaction, PSBT). The transaction signing may be performed by a first secondary electronic device. The first transaction may be transmitted by a first tertiary electronic device to the public ledger network. In one or more examples, the disclosed technique may improve security by avoiding exposing a transaction private key. In one or more examples, the disclosed technique may be advantageous for Air Gapped signing devices, such as electronic devices which do not require to use any radio-frequencies for transmitting a transaction to a public ledger network.

In one or more example methods, generating S108A the first transaction comprising the second hash value comprises generating S108AA the first transaction comprising the second hash using one or more of: a prefix-based operation, a storing operation, and a data encoding operation. In one or more examples, the generation of the first transaction comprising the second hash value can be performed using one or more operations for recording and/or storing data (e.g., the second hash value that includes the first hash) in the public ledger network (e.g., blockchain). For example, a prefix-based operation can be seen as an operation for storing the second hash value by appending a prefix before the second hash value. For example, the storing operation can be seen as an operation for storing the second hash value by applying an OP_RETURN opcode (e.g., a return function which returns the second hash value). For example, a data encoding operation can be seen as an operation for storing the second hash value by encoding the second hash value (e.g., by representing the second hash value in a hexadecimal format). For example, the storing operation can be seen as an operation for storing the second hash value by using the address field.

In one or more example methods, transmitting S108 the first transaction to the public ledger network comprises generating S108C a second transaction comprising one or more parameters associated with the second document. In one or more example methods, transmitting S108 the first transaction to the public ledger network comprises transmitting S108D the second transaction to the public ledger network. In one or more examples, the second transaction can describe parameters associated with the second document, which are stored in the public ledger network. For example, the one or more parameters can be relevant for verification purposes, such as to enable a verifier to verify a validity of an electronic document, using the stored and/recorded hash value. In one or more examples, the one or more parameters can comprise parameters for verification of the electronic document. In one or more example methods, the one or more parameters associated with the second document comprises a hash function and/or a type of data storing operation. The one or more parameters are for example used for description and identification of the operations that happened at recording (e.g., hashing and storing), In one or more examples, the hash function can be seen as the hash function applied for provision of the first hash value and/or the second hash value, respectively. In one or more examples, the hash function can comprise a first hash function (e.g., applied to the first primary part of the first document) and/or a second hash function (e.g., applied to the second document that includes the second primary part, the second secondary part and the signature). In one or more examples, the one or more parameters can be seen as one or more parameters used by a second electronic device (e.g., a verifier) for verifying the electronic document by applying a same hash function to an electronic document for validation. For example, the one or more parameters can identify the hash function originally applied to the first primary part (header) of the first document (e.g., unsigned document) and/or the second document (e.g. signed document) and/or the type of data storing operation (e.g., a prefix-based operation and/or a storing operation and/or a data encoding operation) used for generating the first transaction comprising the second hash value (e.g., for storing the second hash value in the public ledger network).

In one or more example methods, the public ledger network is associated with a public ledger which is an immutable public ledger. In one or more examples, the public ledger network can be seen as a decentralised and/or a distributed public ledger network. In one or more examples, the public ledger network is an immutable public ledger network (e.g., stores and/or maintains any record and/or transaction unalterable).

In one or more example methods, the method 100 comprises obtaining S110 a transaction identifier associated with the second document on the public ledger network. In one or more examples, obtaining the transaction identifier associated with the second document on the public ledger network comprises receiving the transaction identifier e.g., from one or more nodes of the public ledger network. For example, obtaining the transaction identifier associated with the second document on the public ledger network comprises generating the transaction identifier. For example, obtaining the transaction identifier can include that a block associated with the first transaction has been created (e.g., appended to a chain of blocks) in the public ledger network (e.g., a blockchain) and a transaction identifier is returned by one of the nodes. A block may comprise the second hash value (e.g., a unique cryptographic hash) and/or a timestamp and/or transaction data (e.g., the one or more parameters). In one or more examples, the transaction identifier can be the second hash value. In other words, the second hash value can be seen as an identification number for the first transaction. In one or more examples, the transaction identifier is not the second hash value. In other words, for example, the transaction identifier is generated, based on the second hash value, in the public ledger network, with the generated transaction identifier being different from the second hash value. For example, transmitting the first transaction may trigger obtaining any other suitable parameter for identifying the first transaction.

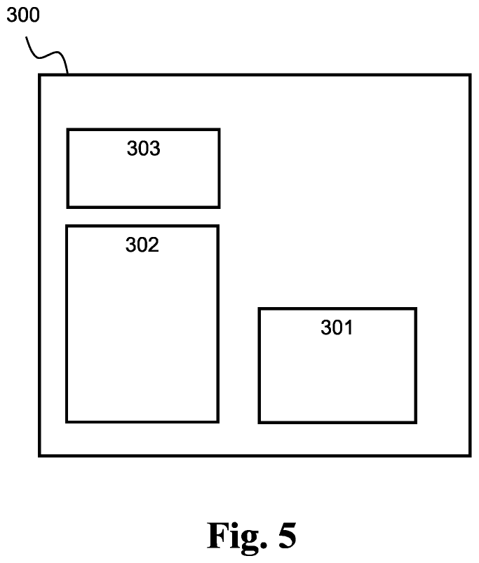

FIG. 5 shows a block diagram of an exemplary first electronic device 300 according to the disclosure. The first electronic device 300 comprises memory circuitry 301, processor circuitry 302, and an interface 303. The first electronic device 300 is configured to perform any of the methods disclosed in FIG. 4. In other words, the first electronic device 300 is configured for enabling verification of a second document. The first electronic device 300 may be seen as a registerer device. The second document is based on a first document by including a signature. For example, the first document is a document sent to a party for signature while the second document is the first document having a signature. The first document comprises a first primary part and a first secondary part.

The first electronic device 300 is configured to determine (e.g., using the processor circuitry 302), based on the first primary part of the first document, a first hash value.

The first electronic device 300 is configured to include (e.g., using the processor circuitry 302) the first hash value in the first secondary part of the first document.

The first electronic device 300 is configured to determine (e.g., using the processor circuitry 302), based on the second document, a second hash value. The second document includes a second primary part, a second secondary part and the signature.

The first electronic device 300 is configured to transmit (e.g., using the processor circuitry 302 and/or the interface 303) a first transaction comprising the second hash value to a public ledger network.

The processor circuitry 302 is optionally configured to perform any of the operations disclosed in FIG. 4 (such as any one or more of: S102, S102A, S104, S106, S106A, S108, S108A, S108AA, S108B, S108C, S108D, S110). The operations of the electronic device 300 may be embodied in the form of executable logic routines (e.g., lines of code, software programs, etc.) that are stored on a non-transitory computer readable medium (e.g., the memory circuitry 301) and are executed by the processor circuitry 302.

Furthermore, the operations of the first electronic device 300 may be considered a method that the first electronic device 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or any other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 5). The memory circuitry 301 is considered a non-transitory computer readable medium.

The memory circuitry 301 may be configured to store a first hash value, a second hash value, one or more parameters, a transaction identifier in a part of the memory.

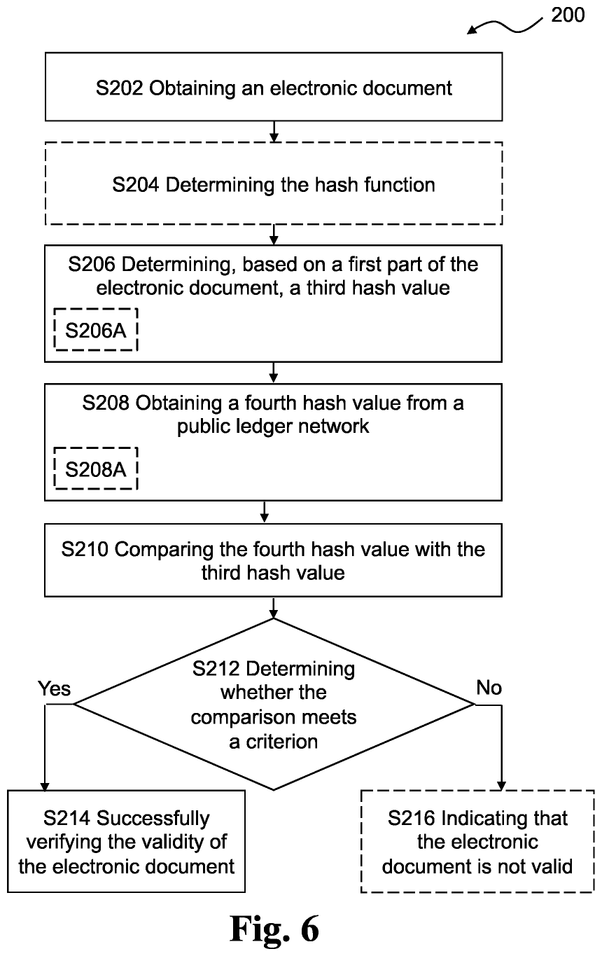

FIG. 6 shows a flow-chart of an exemplary method 200, performed by a second electronic device, for verifying a validity of an electronic document according to the disclosure. The second electronic device may be the second electronic device disclosed herein, such as second electronic device 400 of FIGS. 2, 3, and 7. In one or more examples, the second electronic device can be seen as a verifier device for verifying a validity of an electronic document. For example, the second electronic device verifies if the electronic document is valid, e.g., verifying if the electronic document does not comprise one or more unauthorised modifications (e.g., the electronic document has not been tampered).

In one or more examples, the electronic document can be a generic document (e.g., of non-legal nature) which may have been modified with respect to an original document. In one or more examples, the third document can be a legal document which can be deliberately modified with respect to an original document in attempt to deceive. Such deliberate modification can, for example, be seen as a forgery of the original document, which can deem the original agreement void. A legal document may be seen as a document that can have a legal impact, such as a document which expresses a duty, obligation or right. Examples of legal document may include a contract document, a guideline document, an appendix to a contract document, an engagement letter document, a business terms document, a signature document, or any document which expresses a duty, obligation or right.

In one or more examples, the electronic document can be seen as a third document in relation to a first document (e.g., an unsigned document) and a second document (e.g., a signed document). The third document may or may not have been tampered. In other words, when the second electronic device receives the electronic document, the second electronic device needs identify if the third document is valid. Put differently, the third document may comprise one or more unauthorised modifications. It may also be envisaged that the third document is just the wrong document. The third document may be a signed document. The third document may be a legal document including signatures of one or more signing parties involved in an agreement covered by the legal document. In one or more examples, the signatures are performed via a third party (e.g., via a platform provided by the third party to electronically and/or digitally signing documents and/or agreements). For example, the third party can be seen as a signature certificate entity and/or a signature certificate authority. In one or more examples, the signatures indicate that the one or more parties approve and/or accept one or more clauses comprised in the third document.

The validity of the electronic document can be verified without access to the electronic document (e.g., the third document) by the second electronic device e.g., when there is a dispute between the one or more signing parties. In one or more examples, validity of the electronic document can be verified without access to the electronic document by obtaining the electronic document from the other one or more parties involved in the agreement (e.g., by a direct request to the other one or more parties). For example, the electronic document can be obtained from the other one or more parties and/or by extracting content of the electronic document (e.g., a signed document).

The method 200 comprises obtaining S202 the electronic document. The electronic document comprises a first part and a second part. In one or more examples, the electronic document can be accessed from a platform. For example, obtaining the electronic document comprises extracting content of the electronic document (e.g., a signed document).

In one or more example methods, the first part is a body part of the electronic document. In one or more example methods, the second part of the electronic document includes one or more of: a header part, a footer part, a hidden text part, and a meta data part. In one or more examples, the first part is a body of the electronic document. For example, the body of the electronic document comprises one or more clauses of the electronic document. In one or more examples, the second part is a header of the electronic document. For example, the header of the electronic document comprises information about signing parties (e.g., contracting entities) and/or internal identifiers and/or any other suitable type of information.

In one or more examples, the electronic document is in a format (e.g., in a digital format) such that the electronic document comprises a hash value associated with the first part. For example, the electronic document can be seen as a document object and a hash value associated with the first part. In one or more examples, the electronic document may be in a format such that the electronic document does not comprise a hash value associated with the first part.

For example, determining a hash associated with content of the first part of the electronic document comprises determining the hash by applying a hash function to the first part of the electronic document (e.g., a consistent hash function, such as a same hash function applied to a first document, such as an unsigned version of the electronic document).

The method 200 comprises determining S206, based on the first part of the electronic document, a third hash value. In one or more examples, the electronic document can be seen as a document that the second electronic device (e.g., via a particular party) obtains from the signature certificate authority for verifying validity of the electronic document. In one or more examples, the third hash value can be seen as an identifier of the first part of the electronic document. In other words, the third hash value is an identifier of the body of the first document. For example, the third hash value can be a numeric value (e.g., an integer value). For example, the third hash value can be an alphanumeric value.

The method 200 comprises obtaining S208 a fourth hash value from a public ledger network. The fourth hash value is associated with a second document. In one or more examples, the fourth hash value (e.g., the second hash value) associated with the second document was recorded (e.g., stored) in the public network ledger and denoted second hash value in FIGS. 2, 3, and 4. In one or more examples, a first transaction comprising the fourth hash value was transmitted by a first electronic device (e.g., a registerer device) to the public ledger network (as illustrated in S108 of FIG. 4). In one or more examples, the fourth hash value may be the same of a second hash value of FIG. 1B and FIG. 4.

In one or more examples, the electronic document (e.g., the third document) can be seen as the second document not comprising one or more unauthorised modifications (e.g., not tampered). In one or more examples, the electronic document may comprise one or more unauthorised modifications. The electronic document may not be the same as the second document, e.g., a tampered version of the second document.

The method 200 comprises comparing S210 the fourth hash value with the third hash value. The method 200 comprises determining S212 whether the comparison meets a criterion. The method 200 comprises, upon the comparison meeting the criterion, successfully verifying S214 the validity of the electronic document. In one or more examples, the comparison meets the criterion when the fourth hash value is equal to the third hash value. Put differently, the comparison may meet the criterion when the fourth hash value matches the third hash value. In one or more examples, when comparison meets the criterion (e.g., the fourth hash value is equal to the third hash value), the electronic document (e.g., the third document) can be seen as a true copy of the second document (with no unauthorised modifications (e.g., not tampered)). In one or more examples, the electronic document is a valid document when comparison meets the criterion. For example, the second electronic device successfully verifies the validity of the electronic document when comparison meets the criterion. In other words, the criterion can help disregard a random document, completely unrelated to the task at hand.

In one or more example methods, the electronic document comprises a signature. In one or more examples, the signature is an electronic and/or digital signature. In one or more examples, the electronic document comprises one or more signatures of one or more signing parties involved in an agreement covered by the legal document. In one or more examples, the one or more signatures are performed via a signature certificate entity (e.g., via a platform). In one or more examples, the electronic document can be seen as a document that the second electronic device (e.g., via a particular party) obtains from the signature certificate entity for verifying validity of the electronic document. The second electronic device may verify the validity of the electronic document ensuring that a particular party is singing a reliable document (e.g., not tampered).

In one or more example methods, determining S206 the third hash value comprises determining S206A the third hash value by applying a hash function to the first part (including the signature) and the second part of the electronic document. In one or more examples, a hash function can be seen as a cryptographic function (e.g., a one-way cryptographic function) for integrity protection. In one or more examples, the hash function takes as input the electronic document (as a whole: the first part, and the second part) and outputs the third hash value. In one or more examples, the hash function is a same hash function applied to the second document, whose hash value (e.g., fourth hash value) is stored in the public ledger. For example, the fourth hash value is compared, by the second electronic device, with the third hash value for verifying the validity of the electronic document.

In one or more example methods, the method 200 comprises determining S204 the hash function based on transaction data from the public ledger network. For example, the transaction data is associated with a second transaction transmitted by a first electronic device (e.g., a registerer device) for enabling verification of the electronic document. For example, the second transaction comprises one or more parameters associated with the second document (e.g., whose hash is stored in the public ledger). For example, the one or more parameters can comprise information relevant for verification of the electronic document. In one or more example methods, the one or more parameters associated with the second document comprises a hash function and/or a type of data storing operation (e.g., a prefix-based operation and/or a storing operation and/or a data encoding operation).

In one or more example methods, obtaining S208 the fourth hash value from the public ledger comprises obtaining S208A the fourth hash value by searching for the fourth hash value in the public ledger. For example, the fourth hash value is obtained, e.g., received and/or retrieved from the public ledger. In one or more examples, a data storing operator (e.g., which performs an operation for storing the fourth hash value in the public ledger) may output one or more hash values associated with one or more transactions transmitted (e.g., recorded) to the public ledger network (e.g., blockchain). In one or more examples, searching for the fourth hash value in the public ledger network comprises comparing the fourth hash value with the one or more hash value outputted by the data storing operator. In one or more examples, searching for the fourth hash value in the public ledger network can be performed by the second electronic device by using a transaction identifier associated with the second document on the public ledger network. The transaction identifier associated with the second document may be shared by a particular party with the one or more signing parties for verifying the validity of the electronic document (e.g., a signed document).

In one or more example methods, the method 200 comprises, upon the comparison not meeting the criterion, indicating S216 that the electronic document is not valid. In one or more examples, when comparison does not meet the criterion (e.g., the fourth hash value is not equal to the third hash value), the electronic document comprises one or more unauthorised modifications. The electronic document may not be the same as the second document. The electronic document and the second document are not equivalent. The electronic document may be a tampered document. In one or more examples, when comparison does not meet the criterion (e.g., the fourth hash value is not equal to the third hash value), the electronic document comprises significant modifications in relation to the second document. In other words, the electronic document may not be related to the second document (e.g., the electronic document may not be based on the second document). For example, the electronic document may be a non-legal document and the second document may be a legal document. For example, the second electronic device verifies that the electronic document is not valid.

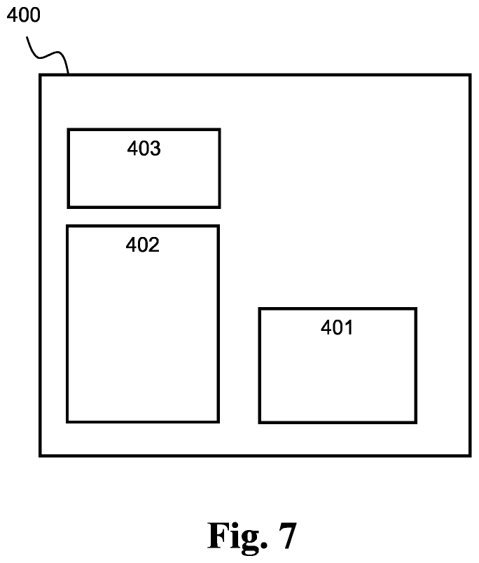

FIG. 7 shows a block diagram of an exemplary second electronic device 400 according to the disclosure. The second electronic device 400 comprises memory circuitry 401, processor circuitry 402, and an interface 403. The second electronic device 400 is configured to perform any of the methods disclosed in FIG. 6. In other words, the second electronic device 400 is configured for verifying a validity of an electronic document. In other words, the second electronic device 400 can be seen as a verifier device, such as an integrity verifier electronic device.

The second electronic device 400 is configured to obtain (e.g., using the interface 403 and/or the memory circuitry 401) the electronic document. The electronic document comprises a first part and a second part.

The second electronic device 400 is configured to determine (e.g., using the processor circuitry 402), based on the first part of the electronic document, a third hash value.

The second electronic device 400 is configured to obtain (e.g., using the interface 403 and/or the memory circuitry 401) a fourth hash value from a public ledger network. The fourth hash value is associated with a second document.

The second electronic device 400 is configured to compare (e.g., using the processor circuitry 402 and/or memory circuitry 401) the fourth hash value with the third hash value. The second electronic device 400 is configured to determine (e.g., using the processor circuitry 402) whether the comparison meets a criterion.

The second electronic device 400 is configured to, upon the comparison meeting the criterion, successfully verifying (e.g., using the processor circuitry 402) the validity of the electronic document.

The processor circuitry 402 is optionally configured to perform any of the operations disclosed in FIG. 6 (such as any one or more of: S202, S204, S206, S206A, S208, S208A, S210, S212, S214, S216). The operations of the electronic device 400 may be embodied in the form of executable logic routines (e.g., lines of code, software programs, etc.) that are stored on a non-transitory computer readable medium (e.g., the memory circuitry 401) and are executed by the processor circuitry 402.

Furthermore, the operations of the second electronic device 400 may be considered a method that the second electronic device 400 is configured to carry out. Also, while the described functions and operations may be implemented in software, such functionality may as well be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or any other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 7). The memory circuitry 401 is considered a non-transitory computer readable medium.

The memory circuitry 401 may be configured to store a third hash value, a fourth hash value, transaction data in a part of the memory.

Embodiments of methods and products (first electronic device and second electronic device) according to the disclosure are set out in the following items:

Item 1. A method, performed by a first electronic device, for enabling verification of a second document, wherein the second document is based on a first document by including a signature, wherein the first document comprises a first primary part and a first secondary part, the method comprising:
determining, based on the first primary part of the first document, a first hash value;
including the first hash value in the first secondary part of the first document;
determining, based on the second document, a second hash value, wherein the second document includes a second primary part, a second secondary part and the signature; and
transmitting a first transaction comprising the second hash value to a public ledger network.

Item 2. The method according to item 1, wherein the signature is an electronic and/or digital signature.

Item 3. The method according to any of the previous items, wherein determining the first hash value comprises:
determining the first hash value by applying a hash function to the first primary part of the first document.

Item 4. The method according to any of the previous items, wherein determining the second hash value comprises:
determining the second hash value by applying a hash function to the second document that includes the second primary part, the second secondary part and the signature.

Item 5. The method according to any of the previous items, wherein the second secondary part of the second document is based on the first secondary part of the first document.

Item 6. The method according to any of the previous items, wherein transmitting the first transaction comprising the second hash value to the public ledger network comprises:
generating the first transaction comprising the second hash value; and
transmitting the first transaction to the public ledger network.

Item 7. The method according to item 6, wherein generating the first transaction comprising the second hash value comprises:
generating the first transaction comprising the second hash value using one or more of: a prefix-based operation, a storing operation, and a data encoding operation.

Item 8. The method according to any of the previous items, wherein transmitting the first transaction to the public ledger network comprises:
generating a second transaction comprising one or more parameters associated with the second document; and
transmitting the second transaction to the public ledger network.

Item 9. The method according to item 8, wherein the one or more parameters associated with the second document comprises a hash function and/or a type of data storing operation.

Item 10. The method according to any of the previous items, wherein the first primary part is a body part of the first document, and wherein the first secondary part of the first document includes one or more of: a header part, a footer part, a hidden text part, a signature part, and a meta data part.

Item 11. The method according to any of the previous items, wherein the second primary part is a body part of the second document, and wherein the second secondary part of the second document includes one or more of: a header part, a footer part, a hidden text part, a signature part, and a meta data part.

Item 12. The method according to any of the previous items, wherein the public ledger network is associated with a public ledger which is an immutable public ledger.

Item 13. The method according to any of the previous items, the method comprises:
obtaining a transaction identifier associated with the second document on the public ledger network.

Item 14. A method, performed by a second electronic device, for verifying a validity of an electronic document, the method comprising:
obtaining the electronic document, wherein the electronic document comprises a first part and a second part;
determining, based on the first part of the electronic document, a third hash value;
obtaining a fourth hash value from a public ledger network, wherein the fourth hash value is associated with a second document;
comparing the fourth hash value with the third hash value;
determining whether the comparison meets a criterion; and
upon the comparison meeting the criterion, successfully verifying the validity of the electronic document.

Item 15. The method according to item 14, wherein the electronic document comprises a signature.

Item 16. The method according to item 15, wherein determining the third hash value comprises:
determining the third hash value by applying a hash function to the first part, and the second part of the electronic document.

Item 17. The method according to item 16, the method comprises:
determining the hash function based on transaction data from the public ledger network.

Item 18. The method according to any of items 14-16, wherein obtaining the fourth hash value from the public ledger comprises:
obtaining the fourth hash value by searching for the fourth hash value in the public ledger network.

Item 19. The method according to any of items 14-17, the method comprising:
upon the comparison not meeting the criterion, indicating that the electronic document is not valid.

Item 20. The method according to any of items 14-18, wherein the first part is a body part of the electronic document, and wherein the second part of the first document includes one or more of: a header part, a footer part, a hidden text part, and a meta data part.

Item 21. A first electronic device comprising memory circuitry, processor circuitry, and an interface, wherein the first electronic device is configured to perform any of the methods according to any of items 1-13.

Item 22. A computer readable storage medium storing one or more programs, the one or more programs comprising instructions, which when executed by a first electronic device cause the first electronic device to perform any of the methods of items 1-13.

Item 23. A second electronic device comprising memory circuitry, processor circuitry, and an interface, wherein the second electronic device is configured to perform any of the methods according to any of items 14-20.

Item 24. A computer readable storage medium storing one or more programs, the one or more programs comprising instructions, which when executed by a second electronic device cause the second electronic device to perform any of the methods of items 14-20.

The use of the terms “first”, “second”, “third” and “fourth”, “primary”, “secondary”, “tertiary” etc. does not imply any particular order but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1A-7 comprise some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented.

Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a first electronic device, for enabling verification of a second document, wherein the second document is based on a first document by including a signature, wherein the first document comprises a first primary part and a first secondary part, the method comprising:
determining, based on the first primary part of the first document, a first hash value;
including the first hash value in the first secondary part of the first document;
determining, based on the second document, a second hash value, wherein the second document includes a second primary part, a second secondary part and the signature; and
transmitting a first transaction comprising the second hash value to a public ledger network.

2. The method according to claim 1, wherein the signature is an electronic and/or digital signature.

3. The method according to claim 1, wherein determining the first hash value comprises:
determining the first hash value by applying a hash function to the first primary part of the first document.

4. The method according to claim 1, wherein determining the second hash value comprises:
determining the second hash value by applying a hash function to the second document that includes the second primary part, the second secondary part and the signature.

5. The method according to claim 1, wherein the second secondary part of the second document is based on the first secondary part of the first document.

6. The method according to claim 1, wherein transmitting the first transaction comprising the second hash value to the public ledger network comprises:
generating the first transaction comprising the second hash value; and
transmitting the first transaction to the public ledger network.

7. The method according to claim 1, wherein the first primary part is a body part of the first document, and wherein the first secondary part of the first document includes one or more of: a header part, a footer part, a hidden text part, a signature part, and a meta data part.

8. A method, performed by a second electronic device, for verifying a validity of an electronic document, the method comprising:
obtaining the electronic document, wherein the electronic document comprises a first part and a second part;
determining, based on the first part of the electronic document, a third hash value;
obtaining a fourth hash value from a public ledger network, wherein the fourth hash value is associated with a second document;
comparing the fourth hash value with the third hash value;
determining whether the comparison meets a criterion; and
upon the comparison meeting the criterion, successfully verifying the validity of the electronic document.

9. The method according to claim 8, wherein the electronic document comprises a signature.

10. The method according to claim 9, wherein determining the third hash value comprises:
determining the third hash value by applying a hash function to the first part, the second part of the electronic document.
